(19) United States
(12) Patent Application Publication
(10) Pub. No.: US 2026/0153352 A1
(43) Pub. Date: Jun. 4, 2026

(54) METHOD AND DEVICE FOR CLASSIFYING ROAD INTERSECTIONS

(71) Applicant: Robert Bosch GmbH, Stuttgart (DE)

(72) Inventors: Bogdan-Alexandru Kandra, Cluj-Napoca (RO); Mihai Barbulescu, Cluj-Napoca (RO)

(21) Appl. No.: 19/391,012

(22) Filed: Nov. 17, 2025

(30) Foreign Application Priority Data
Nov. 29, 2024 (DE) 10 2024 211 461.8

(51) Int. Cl. G01C 21/00

(52) U.S. Cl. CPC G01C 21/3822; G01C 21/3848

(57) ABSTRACT

A computer-implemented method for classifying road intersections by means of GPS data, in particular from a plurality of vehicles in a fleet. The method includes: using existing GPS data points of vehicle movements, which were captured using GPS sensors of the vehicles at at least one road intersection; converting the captured GPS data points into a 2D contour by determining a center point of the road intersection and creating a polygon that represents a 2D contour of the road intersection; encoding the 2D contour of the road intersection using elliptic Fourier descriptors using a Fourier transform method and classifying the encoded data into different intersection types.

### BACKGROUND INFORMATION

The related art includes a plurality of methods for mapping roads and recognizing intersections using GPS data, sensor data, and various algorithms in order to generate accurate maps and intersection information.

U.S. Patent Application No. US 2023/0341239 A1 describes a system for automatically mapping a road segment, comprising at least one processor that receives a plurality of images recorded by at least one camera mounted on a vehicle while the vehicle was traveling along the road segment, to convert each of the plurality of images into a corresponding top-view image to provide a plurality of top-view images, to aggregate the plurality of top-view images in order to provide an aggregated top-view image of the road segment, to analyze the aggregated top-view image in order to identify at least one road feature associated with the road segment, to automatically annotate the at least one road feature relative to the aggregated top-view image, and to output the aggregated top-view image including the annotated at least one road feature to at least one memory.

An object of the present invention is to provide a method for the precise classification of road intersections on the basis of GPS data.

### SUMMARY

The present invention relates to a computer-implemented method for classifying road intersections by means of GPS data from a plurality of vehicles in a fleet. According to an example embodiment of the present invention, the method comprises using existing GPS data points of vehicle movements at road intersections and converting these data into a 2D contour by determining a center point of the road intersection and creating a polygon. This contour is subsequently encoded using elliptic Fourier descriptors (EFDs) and processed by Fourier transform in order to classify the road intersections into different intersection types.

GPS data points are the positions captured by GPS sensors of the vehicles. These data points provide information about the movements of vehicles near or within road intersections. A 2D contour is a two-dimensional representation of the intersection geometry, which is created by connecting the vertices of a polygon that encloses the road intersection. Elliptic Fourier descriptors are mathematical tools for encoding the shape of the 2D contour in order to prepare the data for classification. The Fourier transform is a mathematical method for decomposing the contour data into frequency components, namely elliptic Fourier descriptors, which are relevant for classification.

One advantage of the method of the present invention is that the precise encoding of the intersection geometries and their subsequent classification makes more accurate recognition and categorization of the intersection types possible. This leads to improved analysis of road infrastructure and supports applications in navigation and autonomous driving.

Advantageously, according to an example embodiment of the present invention, the classification of the intersection types can be carried out by a trained deep neural network (DNN). A deep neural network is a multi-layered neural network that is trained on large amounts of data to recognize complex patterns.

As a result, the accuracy of the classification of the intersection type is further increased, since the DNN is able to learn from a wide variety of examples and recognize subtle differences between different intersection types.

Advantageously, the DNN can be trained on the intersection types of a T-intersection, an X-intersection and/or a roundabout. A T-intersection is a road intersection where one road meets another and forms a T-shape. An X-intersection is a four-way intersection in which two roads intersect one another. A roundabout is a circular intersection where traffic flows in a circle around a central island.

As a result, the system is specifically trained to recognize the most common intersection types, which facilitates its use in real traffic environments.

Advantageously, according to an example embodiment of the present invention, the 2D contour of the road intersection can be formed by an iterative calculation of vertices of the polygon around the center point of the intersection. An iterative calculation means that the vertices of the polygon are determined step by step through repeated calculations, in order to achieve the best possible approximation of the actual intersection geometry.

As a result, the accuracy of the contour representation of the intersection is improved, which makes more precise classification possible.

Advantageously, according to an example embodiment of the present invention, the Fourier coefficients or elliptic Fourier descriptors (EFDs) can be calculated by a forward transformation of the 2D contour of the road intersection. Fourier coefficients or elliptic Fourier descriptors (EFDs) are the parameters that describe the frequency components of the contour data, and a forward transformation is the process of calculating these coefficients.

As a result, the contour data are efficiently converted into a format, such as a numerical matrix, that is suitable for further processing and classification.

Advantageously, according to an example embodiment of the present invention, the Fourier coefficients can be encoded into a fixed numerical matrix in order to ensure a uniform input size for the DNN. A fixed numerical matrix is a structured representation of the data that is in a fixed format in order to ensure that the DNN always receives consistent input data.

As a result, consistent processing of the data in the neural network is ensured, which increases classification efficiency.

Advantageously, according to an example embodiment of the present invention, the DNN can classify road intersections in real time or near real time. Real-time classification means that the intersections are analyzed and classified directly during data acquisition.

As a result, an immediate and dynamic analysis of the traffic environment is made possible, which is particularly advantageous for autonomous driving applications.

Advantageously, according to an example embodiment of the present invention, the road intersections can be entered into a digital map using the classified intersection types. A digital map is a graphical representation of the road infrastructure, in which the classified intersections are stored and displayed.

As a result, a visualization of the road infrastructure with additional information on the intersection types is provided, which facilitates navigation in traffic.

Advantageously, according to an example embodiment of the present invention, the collected GPS data can be supplemented by sensor data from other sensors such as a video camera, a radar sensor and/or a lidar sensor. Additional sensor data provide further information about the traffic environment, which supports the GPS data.

As a result, the precision of the recognition of intersections is improved, since a plurality of sensor data sources together make a more comprehensive analysis possible.

Advantageously, the classified intersection types can be used to improve a navigation system to assist a driver and/or to improve a control system of a self-driving or semi-autonomous vehicle. Navigation systems use these data to optimize route guidance, while control systems in autonomous vehicles use the intersection types to control the self-driving vehicle.

As a result, both safety and efficiency of the traffic-flow are improved by making it possible for systems to respond better to the specific intersection types.

Advantageously, according to an example embodiment of the present invention, the encoded data can be used for the continuous improvement of the DNN by using the new encoded data as training data for the DNN and/or by automatically recognizing new intersection types. This means that the DNN is constantly being trained with new training data in order to further improve classification.

As a result, the performance of the system is continuously increased, since it can adapt to new traffic situations and intersection types.

Advantageously, the GPS data points can be filtered on the basis of predefined criteria such as vehicle speed, direction of travel and/or distance from the center point of the road intersection, in order to eliminate faulty GPS data points. This ensures a more precise representation of the intersection geometry.

As a result, the accuracy of the data is further increased by eliminating noise and faulty GPS data points.

Advantageously, an iterative calculation of the vertices of the polygons can be carried out by a weighted consideration of GPS data points according to the movement of the vehicle and/or the direction of travel of the vehicle. The weighting ensures that the relevant GPS data are given greater consideration when calculating the contours.

As a result, the contour is adapted even more precisely to the actual movements of the vehicles.

Advantageously, the Fourier transform can be optimized so that at most the first ten elliptic Fourier descriptors (EFDs) are used for encoding, so that the amount of data is minimized. This reduces the complexity of the data and avoids distortions.

As a result, the efficiency of the system is increased, without affecting the accuracy of the classification.

Advantageously, a fixed numerical matrix can be normalized with the elliptic Fourier descriptors (EFDs) for input into the DNN, so that better comparability between different intersection types is ensured. Normalization means that the data are converted into a standardized format, in order to make uniform processing possible.

As a result, the classification of intersection types is more consistent and more reliable.

A further object of the present invention is a device for performing the method of the present invention. According to an example embodiment of the present invention, the device includes a processing unit that is configured to process GPS data points of vehicle movements at the center point of the road intersection on the basis of the captured GPS data and subsequently generates a polygon that represents the road intersection. The 2D contour serves as the basis for further encoding and classification of the intersection to process at least one road intersection and to convert the data into a 2D contour by determining a center point and creating a polygon,
a storage unit that is configured to store the calculated 2D contours and/or encoded Fourier coefficients,
a classification unit that is configured to classify the encoded data of the road intersection contour into different intersection types by means of a trained deep neural network (DNN), and
a communication interface that is configured to transmit the classified intersection types to a navigation system and/or a control system of a vehicle.

According to an example embodiment of the present invention, the device comprises a processing unit that processes GPS data points of vehicle movements at at least one road intersection. These GPS data points are used to create a 2D contour of the road intersection. For this purpose, the processing unit initially determines the center point of the road intersection on the basis of the captured GPS data and subsequently generates a polygon that represents the road intersection. The 2D contour serves as the basis for further encoding and classification of the intersection.

The storage unit is configured to store the 2D contours generated by the processing unit and/or the encoded Fourier coefficients calculated from them. As a result, the data are provided for subsequent processing steps and applications.

The device also comprises a classification unit that is designed to classify the encoded data of the road intersection contour into different intersection types by means of a trained deep neural network (DNN). The classification unit uses the mathematical properties of the encoded contours to reliably recognize intersection types such as T-intersections, X-intersections or roundabouts.

According to an example embodiment of the present invention, a communication interface makes it possible to transmit the classified intersection types to a navigation system and/or a control system of a vehicle, for example to an external server for further processing. This transmission ensures that the classified data can be used in real time or near real time in applications such as route planning or the control of autonomous vehicles.

The modular structure of the device of the present invention allows for flexible integration into existing vehicle and traffic infrastructures. It ensures precise and efficient processing of large amounts of data and supports dynamic adaptation to different traffic conditions and intersection types.

### BRIEF DESCRIPTION OF THE DRAWINGS

The present invention is explained with reference to the following figures.

FIG. 1 shows a schematic representation of the first 10 harmonic functions of a typical T-shaped intersection contour, according to an example embodiment of the present invention.

FIG. 2 shows a schematic representation of paths of the captured GPS data points and the generated 2D contour, according to an example embodiment of the present invention.

FIG. 3 shows a schematic representation of an example embodiment of a device for performing the method of the present invention described above.

### DETAILED DESCRIPTION OF EXAMPLE EMBODIMENTS

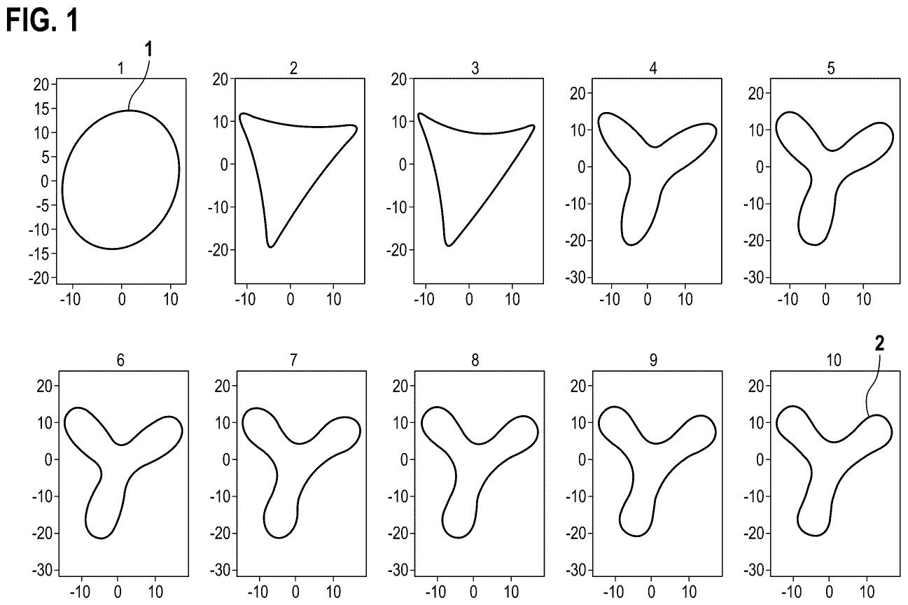

FIG. 1 schematically shows the first 10 harmonic functions of a typical T-shaped intersection contour that was generated by applying elliptic Fourier descriptors (EFDs) to the GPS data of the vehicle fleet. The underlying algorithm uses the properties of EFDs to represent a closed 2D contour as a finite series of elliptic harmonic functions. This method is similar to the Fourier transform of a one-dimensional signal, where the waveform is approximated by a finite number of sine and cosine terms.

In this case, each harmonic component of the contour of the road intersection represents specific geometric features of the road intersection. The number of harmonic functions used, here the first ten, starting with the first harmonic function 1 up to the tenth harmonic function 2, determines the accuracy of the contour representation. The quality of the representation of the contour of the road intersection is influenced by the number of harmonics; with an increasing number, the accuracy of the representation of the contour improves. These harmonics are described by four constant parameters for each harmonic: an, bn, cn and dn. These parameters control the shape of the elliptic components that contribute to the reconstruction of the contour.

Empirical studies show that, for a typical intersection, a minimum number of 10 harmonics is required to achieve sufficient accuracy of over 90% in the representation of the intersection contour. This is particularly important, since the quality of the contour significantly contributes to the precise classification of the intersections, which is carried out in later steps by a deep neural network (DNN). The theoretical basis for this accuracy is also supported by studies on Fourier transforms.

In the next stage of the method, the 2D contour is encoded by calculating the Fourier coefficients for the generated polygon. The result of this step is a data structure containing the four parameters an, bn, cn and dn for each of the n harmonic functions, where n represents the number of harmonic functions used. Subsequently, the Fourier coefficients are used to encode the contour into a fixed matrix of numbers, which is used for training the DNN.

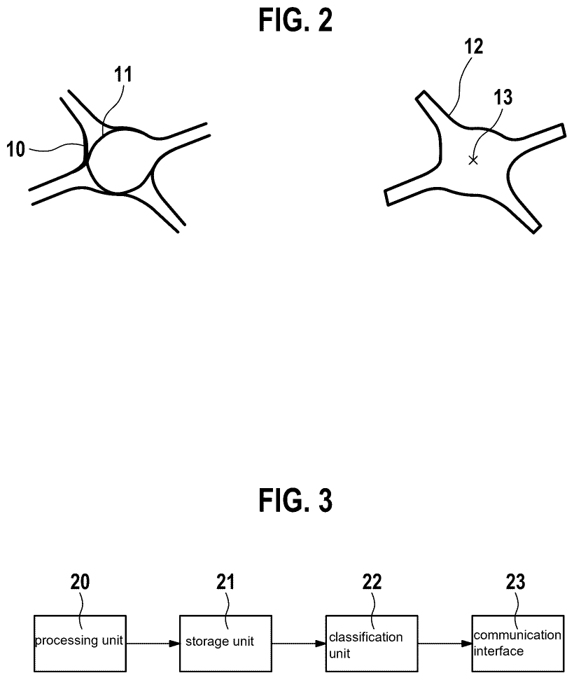

FIG. 2 schematically shows in the left-hand representation a sketch of paths 10, 11 of the captured GPS data points of the individual vehicles, which are represented as discontinuous lines in a 3D space. These paths 10, 11 of the GPS data points comprise the captured vehicle paths at road intersections and represent the starting point for the contour construction. Contour construction is the first step of the proposed algorithm, which aims to transform the paths 10, 11 of the vehicles into a 2D representation. The elevation data are ignored in order to reduce complexity, and the data points are converted into a 2D contour that forms polygon 12 in the right-hand representation.

The next step in contour construction, as indicated in the right-hand representation, is to convert the vehicle paths into polygon 12 through iterative steps. Initially, a center point or centroid 13 of the GPS data is calculated, followed by the creation of a minimal initial polygon with the three points closest to the center point. Subsequently, the polygon is iteratively extended by adding further GPS points until all GPS data points are included in the contour. This method ensures that the contour of the road intersection fully encloses the recorded vehicle paths and accurately represents the intersection geometry.

In the next phase of the method, the resulting contour is decomposed using elliptic Fourier descriptors. Here, the contour is described by a series of elliptic harmonic functions as in FIG. 1, wherein the number of harmonic functions used determines the accuracy of the contour reconstruction. Empirical studies have shown that at least 10 harmonic functions are required to achieve an accuracy of over 90%. However, in cases where there are no storage or computation time limitations, up to 50 harmonic functions can be used to achieve nearly 100% contour accuracy.

After the contour is encoded, the deep neural network (DNN) is trained to classify the intersection contours into user-defined classes such as T-intersections, X-intersections or roundabouts. The specific DNN model can use different neural network architectures to solve this classification problem. The classification is carried out on the basis of the previously encoded data, which was generated by the Fourier coefficients. Once enough data are available, the DNN will be trained to accurately classify future input data and make a robust classification of road intersections possible.

FIG. 3 shows a schematic representation of an embodiment of a device for performing the method described above. The device consists of four functional units, represented as rectangular boxes and connected by arrows that illustrate the data flow between the units.

The first box represents the processing unit 20, which is configured to process GPS data points 10, 11 of vehicle movements at at least one road intersection. This unit takes GPS data points 10 and 11 and converts them into a 2D contour of the road intersection. Initially, a center point of the intersection 13 is determined, and subsequently a polygon 12 is generated that represents the geometry of the road intersection. The arrow connection to the storage unit 21 symbolizes the transfer of the processed data.

The second box represents the storage unit 21, which is configured to store the calculated 2D contours and/or the Fourier coefficients encoded from them. The storage unit serves as a temporary storage to hold the processed data for the subsequent steps. The arrow connection to the classification unit 22 shows that the stored data are moving to the next processing stage.

The third box symbolizes the classification unit 22, which is configured to analyze the encoded data of the road intersection contour. This unit uses a trained deep neural network (DNN) to classify the road intersections into different intersection types. Examples of such intersection types are T-intersections, X-intersections and roundabouts. The arrow connection to communication interface 23 shows the transfer of the classified results.

The fourth box represents the communication interface 23, which is configured to transmit the classified intersection types, for example, to an external server for further processing, to a navigation system and/or to a control system of a vehicle. This transmission takes place in real time or near real time in order to make the classified data usable for applications such as navigation or autonomous control.

The arrows between the boxes illustrate the sequential data processing flow, from the capture and processing of GPS data to the transmission of the classified intersection types to the target systems.

1-15. (canceled)

16. A computer-implemented method for classifying road intersections using GPS data from a plurality of vehicles in a fleet, the method comprising the following steps:
using existing GPS data points of vehicle movements, which were captured using GPS sensors of the vehicles at at least one road intersection;
converting the captured GPS data points into a 2D contour by determining a center point of the at least one road intersection and creating a polygon that represents a 2D contour of the at least one road intersection; and
encoding the 2D contour of the at least one road intersection using elliptic Fourier descriptors (EFDs) using a Fourier transform method to provide encoded data, and classifying the encoded data into different intersection types.

17. The method according to claim 16, wherein the classification into different intersection types is carried out by a trained deep neural network (DNN).

18. The method according to claim 17, wherein the DNN is trained on the intersection types of a T-intersection and/or an X-intersection and/or a roundabout.

19. The method according to claim 16, wherein the 2D contour of the road intersection is formed by an iterative calculation of vertices of the polygon around the center point of the at least one road intersection.

20. The method according to claim 17, wherein Fourier coefficients are calculated by a forward transformation of the 2D contour of the at least one road intersection.

21. The method according to claim 20, wherein the Fourier coefficients are encoded into a fixed numerical matrix to ensure a uniform input size for the DNN.

22. The method according to claim 17, wherein the DNN classifies road intersections in real time or near real time.

23. The method according to claim 16, wherein the at least one road intersection is entered in a digital map with the classified intersection types.

24. The method according to claim 16, wherein the captured GPS data points are supplemented by sensor data from other sensors, the other sensors including a video camera and/or a radar sensor and/or a lidar sensor.

25. The method according to claim 16, wherein the classified intersection types are used: (i) to improve a navigation system to assist a driver and/or (ii) to improve a control system of a self-driving or semi-autonomous vehicle.

26. The method according to claim 17, wherein the encoded data are used for the continuous improvement of the DNN: (i) by using new encoded data as training data of the DNN and/or (ii) by automatically recognizing new intersection types and training and adding new DNNs for the intersection types using associated training data of the new intersection types.

27. The method according to claim 16, wherein the GPS data points are filtered based on predefined criteria, including: (i) a speed of the vehicles and/or (ii) a direction of travel and/or (iii) a distance of the vehicles from the center point of the road intersection, the GPS data points being filted so that faulty GPS data points are filtered out to generate precise 2D contours.

28. The method according to claim 16, wherein an iterative calculation of vertices of the polygon is carried out by a weighted consideration of the GPS data points according to: (i) a movement of the vehicles and/or a direction of travel of the vehicles.

29. The method according to claim 16, wherein the Fourier transform is optimized so that at most a first ten elliptic Fourier descriptors are used for the encoding, so that an amount of data is minimized and minimal distortion of the contour compared to an actual contour of the road intersection is ensured.

30. A device configued to classify road intersections using GPS data from a plurality of vehicles in a fleet, the device comprising:
a processing unit configured to process GPS data points of vehicle movements of the vehicles at at least one road intersection and to convert the GPS data points into a 2D contour to provide encoded data of the at least one road intersection contour by determining a center point and creating a polygon;
a storage unit configured to store the calculated 2D contour and/or encoded Fourier coefficients;
a classification unit configured to classify the encoded data of the road intersection contour into different intersection types using a trained deep neural network; and
a communication interface configured to transmit the classified intersection types to a navigation system and/or to a control system of a vehicle.
